(19) United States
(12) Patent Application Publication
(10) Pub. No.: US 2015/0047054 A1
(43) Pub. Date: Feb. 12, 2015

(54) METHOD AND SERVER FOR PROVIDING ONLINE GAME CONTROL SERVICE

(71) Applicants: Woon Yong Kim, Suwon-si (KR); Dong Won Kim, Chungcheongnam-do (KR)

(72) Inventors: Woon Yong Kim, Suwon-si (KR); Dong Won Kim, Chungcheongnam-do (KR)

(73) Assignee: INTELLECTUAL DISCOVERY CO., LTD., Seoul (KR)

(21) Appl. No.: 14/363,741

(22) PCT Filed: Mar. 30, 2012
(86) PCT No.: PCT/KR2012/002374

§ 371 Date: Oct. 24, 2014

(30) Foreign Application Priority Data
Dec. 9, 2011 (KR) 10-2011-0132302

(51) Int. Cl. G06F 21/50; A63F 13/35; H04L 29/06

(52) U.S. Cl. CPC G06F 21/50; H04L 63/10; A63F 13/35; G06F 2221/2137
USPC 726/28

(57) ABSTRACT

Disclosed is a skill for intercepting access to a game server by users who are under a predetermined age when a game access time reaches a predetermined time. A method for providing an online game control service includes: by a game management server, determining whether a present time belongs to a time range between a predetermined first time and a predetermined second time that is prior to the predetermined first time; searching users who are accessing the game management server and are under a predetermined age when the present time is included in the time range; and intercepting access to the game management server by the searched users who are under the predetermined age when the present time reaches the predetermined first time.

### TECHNICAL FIELD

The present invention relates to a method and server for providing an online game control service for intercepting access to a game server by users who are under a predetermined age when a game access time reaches a predetermined time.

### BACKGROUND ART

Recently, the national game industry with respect to online games has been greatly developed with the support of the information technology (IT) infrastructure. Accordingly, the government has also accepted online games as a dynamic force that will lead Korea in the age of digital culture contents.

However, when the online game industry is scrutinized, adverse effects and various kinds of losses such as addiction to games and item transaction fraud are seen, together with rapid expansion of online markets are occurring in many places. Particularly, juvenile Internet addiction phenomena have reached a significant level.

Internet addiction damages users and people they know, and particularly, their parents urgently need to proactively establish measures for preventing minor children's Internet addiction (online game addiction).

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a method and server for providing an online game control service for intercepting access to a game server by users who are under a predetermined age when a game access time reaches a predetermined time.

The present invention has been made in an effort to provide a method and server for providing an online game control service for outputting a shutdown message as a message for alerting interception of game access when a present time is reached to terminals of users who are under a predetermined age at a predetermined time before a game access time reaches the predetermined time, and intercepting access to a game server by the users who are under the predetermined age when the game access time reaches the predetermined time.

### Technical Solution

An exemplary embodiment of the present invention provides a method for providing an online game control service, including: by a game management server, determining whether a present time belongs to a time range between a predetermined first time and a predetermined second time that is prior to the predetermined first time; searching for users who are accessing the game management server and are under a predetermined age when the present time is included in the time range; and intercepting access to the game management server by the searched users who are under a predetermined age when the present time reaches the predetermined first time.

The searching for users who are under the predetermined age includes transmitting a shutdown message as a message for notifying interception of the game access when a present time reaches the predetermined first time to a terminal of the searched user who is under the predetermined age.

The searching for users who are under the predetermined age further includes: searching for users who are playing a game with the users who are under the predetermined age; and transmitting a game playing termination inducing message for terminating the playing of a game to the terminal of the searched user since the access to the game management server by the users who are under the predetermined age is intercepted when the present time reaches the predetermined first time.

The method further includes, after the searching for users who are under the predetermined age: receiving a game playing start input from the terminal of the user who is under the predetermined age; determining whether an expected playing time passed time that is set in proportion to a playing time used for the playing of a game is after the first time from the present time; and intercepting the game playing start of the user who is under the predetermined age when the passed time is after the first time.

The method further includes allowing a game playing start for the user who is under the predetermined age when the passed time is before the first time.

The intercepting of access includes, when the present time reaches the predetermined first time, standing by for access interception until a case is finished when the user who is under the predetermined age is included in one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

The method further includes, after the intercepting of access to a game management server, storing access interception state information of the game management server on the user who is under the predetermined age.

Another embodiment of the present invention provides a method for providing an online game control service, including: by a game management server, determining whether a present time belongs to a time range between a predetermined first time and a predetermined second time that is prior to the predetermined first time; searching for users who are accessing the game management server and are under a predetermined age when the present time is included in the time range; transmitting a shutdown message for notifying interception of game access when the present time reaches the predetermined first time to the user terminal who is under the predetermined age when the present time reaches a predetermined third time included in the time range; and intercepting access to the game management server by the searched users who are under the predetermined age when the present time reaches the predetermined first time.

The intercepting of access includes, when the present time reaches the predetermined first time, standing by for access interception until a case is finished when the user who is under the predetermined age is included in one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

The searching for users who are under the predetermined age further includes: searching for users who are playing a game with the users who are under the predetermined age; and transmitting a game playing termination inducing message for terminating the playing of a game to the terminal of the searched user since the access to the game management server by the users who are under the predetermined age is intercepted when the present time reaches the predetermined first time.

The method further includes, after the searching for users who are under the predetermined age: receiving a game playing start input from the terminal of the user who is under the predetermined age; determining whether an expected playing time passed time that is set in proportion to a playing time used for the playing of a game is after the first time from the present time; and intercepting the game playing start on the user who is under the predetermined age when the passed time is after the first time.

The method further includes allowing a game playing start for the user who is under the predetermined age when the passed time is before the first time.

Yet another embodiment of the present invention provides a server for providing an online game control service, including: a user searcher for searching for users who are accessing a game server and are under a predetermined age when a present time is included in a time range between a predetermined first time and a predetermined second time that is prior to the predetermined first time; a message provider for transmitting a shutdown message for notifying interception of game access when the present time reaches the predetermined first time to the user terminal who is under the predetermined age when the present time reaches a predetermined third time included in the time range; and a controller for intercepting the access to the game server by the searched users who are under the predetermined age when the present time reaches the predetermined first time.

When receiving a game playing start input from the user terminal who is under the predetermined age, the controller determines whether an expected playing time passed time which is set in proportion to a playing time used for the playing of a game is after the first time from the present time, and intercepts the game playing start on the user who is under the predetermined age when the passed time is after the first time.

The controller allows the game playing start of the user who is under the predetermined age when the passed time is before the first time.

The controller searches for users who are playing a game with the users who are under the predetermined age.

The message provider transmits a game playing termination inducing message for terminating the playing of a game to the searched user's terminal since the access to the game management server by the users who are under the predetermined age is intercepted when the present time reaches the predetermined first time.

When the present time reaches the predetermined first time, the controller stands by for access interception until a case is finished when the user who is under the predetermined age is included in the one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

The controller intercepts the access to a game server and stores access intercept state information of the game management server on the users who are under the predetermined age.

Yet another embodiment of the present invention provides a computer readable medium for realizing a method for providing an online game control service, including: by a game management server, determining whether a present time belongs to a time range between a predetermined first time and a predetermined second time that is prior to the predetermined first time; searching for users who are accessing the game management server and are under a predetermined age when the present time is included in the time range; and intercepting access to the game management server by the searched users who are under the predetermined age when the present time reaches the predetermined first time.

Yet another embodiment of the present invention provides a computer readable medium for realizing a method for providing an online game control service, including: by a game server, determining whether a present time belongs to a time range between a predetermined first time and a predetermined second time that is prior to the predetermined first time; searching for users who are accessing the game management server and are under a predetermined age when the present time is included in the time range; transmitting a shutdown message for notifying interception of game access when the present time reaches the predetermined first time of the user terminal who is under the predetermined age when the present time reaches the predetermined third time included in the time range; and intercepting access to the game management server by the searched users who are under the predetermined age when the present time reaches the predetermined first time.

### Advantageous Effects

According to the present invention, the effect of controlling the indiscreet access to a game by the users who are under a predetermined age is generated by intercepting the access to the game server by the users who are under the predetermined age when the game access time reaches a predetermined time.

### DESCRIPTION OF THE DRAWINGS

FIG. 1 shows a flowchart of operation of a method for providing an online game control service according to an exemplary embodiment of the present invention.

FIG. 2 shows a flowchart of operation of a method for intercepting playing of a game in a method for providing an online game control service according to an exemplary embodiment of the present invention.

FIG. 3 shows a flowchart of operation of a method for processing a shutdown exception in a method for providing an online game control service according to an exemplary embodiment of the present invention.

FIG. 4 shows a flowchart of operation of a method for providing an online game control service according to another exemplary embodiment of the present invention.

FIG. 5 shows a flowchart of operation of a method for inducing termination of playing of a game between a user who is under a predetermined age and a user who plays the game in a method for providing an online game control service according to another exemplary embodiment of the present invention.

FIG. 6 shows a block diagram of a server for providing an online game control service according to an exemplary embodiment of the present invention.

FIG. 7 to FIG. 10 show screens for using an item use service according to exemplary embodiments of the present invention.

### MODE FOR INVENTION

An exemplary embodiment of the present invention provides a method for providing an online game control service, including: by a game management server, determining whether a present time belongs to a time range between a predetermined first time and a predetermined second time that is prior to the predetermined first time; searching for users who are accessing the game management server and are under a predetermined age when the present time is included in the time range; and intercepting access to the game management server by the searched users who are under a predetermined age when the present time reaches the predetermined first time.

The searching for users who are under the predetermined age includes transmitting a shutdown message as a message for notifying interception of the game access when a present time reaches the predetermined first time to a terminal of the searched user who is under the predetermined age.

The searching for users who are under the predetermined age further includes: searching for users who are playing a game with the users who are under the predetermined age; and transmitting a game playing termination inducing message for terminating the playing of a game to the terminal of the searched user since the access to the game management server by the users who are under the predetermined age is intercepted when the present time reaches the predetermined first time.

The method further includes, after the searching for users who are under the predetermined age: receiving a game playing start input from the terminal of the user who is under the predetermined age; determining whether an expected playing time passed time that is set in proportion to a playing time used for the playing of a game is after the first time from the present time; and intercepting the game playing start of the user who is under the predetermined age when the passed time is after the first time.

The method further includes allowing a game playing start for the user who is under the predetermined age when the passed time is before the first time.

The intercepting of access includes, when the present time reaches the predetermined first time, standing by for access interception until a case is finished when the user who is under the predetermined age is included in one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

The method further includes, after the intercepting of access to a game management server, storing access interception state information of the game management server on the user who is under the predetermined age.

Another embodiment of the present invention provides a method for providing an online game control service, including: by a game management server, determining whether a present time belongs to a time range between a predetermined first time and a predetermined second time that is prior to the predetermined first time; searching for users who are accessing the game management server and are under a predetermined age when the present time is included in the time range; transmitting a shutdown message for notifying interception of game access when the present time reaches the predetermined first time to the user terminal who is under the predetermined age when the present time reaches a predetermined third time included in the time range; and intercepting access to the game management server by the searched users who are under the predetermined age when the present time reaches the predetermined first time.

The intercepting of access includes, when the present time reaches the predetermined first time, standing by for access interception until a case is finished when the user who is under the predetermined age is included in one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

The searching for users who are under the predetermined age further includes: searching for users who are playing a game with the users who are under the predetermined age; and transmitting a game playing termination inducing message for terminating the playing of a game to the terminal of the searched user since the access to the game management server by the users who are under the predetermined age is intercepted when the present time reaches the predetermined first time.

The method further includes, after the searching for users who are under the predetermined age: receiving a game playing start input from the terminal of the user who is under the predetermined age; determining whether an expected playing time passed time that is set in proportion to a playing time used for the playing of a game is after the first time from the present time; and intercepting the game playing start on the user who is under the predetermined age when the passed time is after the first time.

The method further includes allowing a game playing start for the user who is under the predetermined age when the passed time is before the first time.

Yet another embodiment of the present invention provides a server for providing an online game control service, including: a user searcher for searching for users who are accessing a game server and are under a predetermined age when a present time is included in a time range between a predetermined first time and a predetermined second time that is prior to the predetermined first time; a message provider for transmitting a shutdown message for notifying interception of game access when the present time reaches the predetermined first time to the user terminal who is under the predetermined age when the present time reaches a predetermined third time included in the time range; and a controller for intercepting the access to the game server by the searched users who are under the predetermined age when the present time reaches the predetermined first time.

When receiving a game playing start input from the user terminal who is under the predetermined age, the controller determines whether an expected playing time passed time which is set in proportion to a playing time used for the playing of a game is after the first time from the present time, and intercepts the game playing start on the user who is under the predetermined age when the passed time is after the first time.

The controller allows the game playing start of the user who is under the predetermined age when the passed time is before the first time.

The controller searches for users who are playing a game with the users who are under the predetermined age.

The message provider transmits a game playing termination inducing message for terminating the playing of a game to the searched user's terminal since the access to the game management server by the users who are under the predetermined age is intercepted when the present time reaches the predetermined first time.

When the present time reaches the predetermined first time, the controller stands by for access interception until a case is finished when the user who is under the predetermined age is included in the one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

The controller intercepts the access to a game server and stores access intercept state information of the game management server on the users who are under the predetermined age.

Yet another embodiment of the present invention provides a computer readable medium for realizing a method for providing an online game control service, including: by a game management server, determining whether a present time belongs to a time range between a predetermined first time and a predetermined second time that is prior to the predetermined first time; searching for users who are accessing the game management server and are under a predetermined age when the present time is included in the time range; and intercepting access to the game management server by the searched users who are under the predetermined age when the present time reaches the predetermined first time.

Yet another embodiment of the present invention provides a computer readable medium for realizing a method for providing an online game control service, including: by a game server, determining whether a present time belongs to a time range between a predetermined first time and a predetermined second time that is prior to the predetermined first time; searching for users who are accessing the game management server and are under a predetermined age when the present time is included in the time range; transmitting a shutdown message for notifying interception of game access when the present time reaches the predetermined first time of the user terminal who is under the predetermined age when the present time reaches the predetermined third time included in the time range; and intercepting access to the game management server by the searched users who are under the predetermined age when the present time reaches the predetermined first time.

### Mode for Invention

Hereinafter, a method and server for providing an online game control service according to exemplary embodiments of the present invention will be described with reference to accompanying drawings.

It is obvious that the following exemplary embodiment is a detailed description which is provided for better understanding of the present invention and does not limit the scope of the present invention. Therefore, an equivalent invention which performs the same function as the present invention may also be covered by the scope of the present invention.

In adding reference numerals to components of each drawing, even though the same components are illustrated in different drawings, it is to be noted that these components are denoted by the same reference numerals if possible. In describing exemplary embodiments of the present invention, well-known functions or constructions will not be described in detail since they may unnecessarily obscure the understanding of the present invention.

In addition, in describing components of the present specification, terms such as first, second, A, B, (a), and (b) may be used. These terms are used only to differentiate the components from other components, but the nature, sequence, order, etc., of the corresponding components are not limited by these terms. When a component is “connected”, “coupled”, or “linked” to another component, it is to be noted that the component may be directly connected or linked to the another component, but the component may be “connected”, “coupled”, or “linked” to the another component via another component therebetween.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer to which users access to use game contents. In the case of a game which has a small capacity or a small number of users, a plurality of game programs may be operated by one game server. Further, in the case of a game which has a large capacity or a large number of realtime accessing members, one or more game servers which operate one game may be provided depending on a function of the game.

In addition, middleware for databases or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game in the game. The online game also indicates a game that can be used to buy various kinds of items in the game to play the game more smoothly.

Herein, an item indicates all data that can give assistance to playing the game and can be generally understood as an item in the game. For example, in a role-playing game, an item for further increasing an experience level obtained when a character of a user subdues a monster, an item for changing the appearance of the character, and the like may correspond to the items in the present invention.

In addition, in a sports game, a card item for using a character, an item for increasing a capability level of the character, an item for recovering a condition of the character, an item for increasing a capability level in the game and simultaneously for changing the appearance of the character by mounting the card to the character, and the like, pertain to the items in the present invention. As such, all items that can be used by a character during the play of a game or can be used by a user to apply it to the game pertain to the items in the present invention.

For the items, the duration of use effect may be permanent or limited. In this case, the same kinds of items having different durations are the same items in the present invention. For example, an item “A” for increasing a capability level for one week and an item “A” for increasing a capability level for two weeks may be recognized as the same items although they may be different items from a viewpoint of a database.

In the present invention, a lottery item represents an item like a lottery ticket that provides at least one item to the user. The users may buy the lottery item from an item shop, and may use the lottery item on an “inventory” screen on which the item owned by him can be checked.

In the exemplar case of a sports game, a player character needed for the sports game may be acquired through the lottery item. When the lottery item is used, it can be an item which may allow a random acquisition of one player character from among the player characters belonging to a predetermined range according to the lottery item having a predetermined range (e.g., capability level range). The lottery items are sorted as elements that have different ranges such as a capability level range.

Therefore, the user may acquire an item including a player character needed for execution of a game by use of a lottery item. The lottery items may also be used one by one, and a plurality of lottery items of one kind may be acquired.

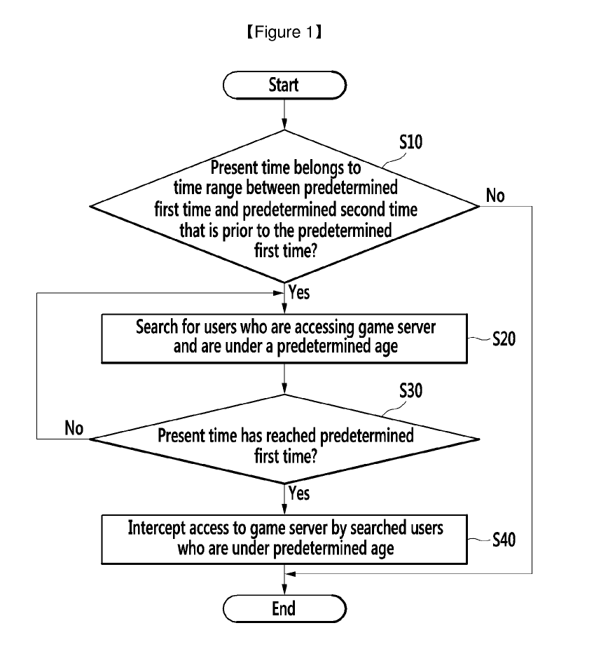

FIG. 1 shows a flowchart on an operation of a method for providing an online game control service according to an exemplary embodiment of the present invention.

Referring to FIG. 1, the method for providing an online game control service according to an exemplary embodiment of the present invention is performed by a server providing an online game control service determining whether a present time belongs to a time range between a predetermined first time and a predetermined second time that is prior to the predetermined first time (S10).

Here, the predetermined first time may be exemplarily 24 o'clock, the predetermined second time may be exemplarily 23 o'clock, and a time range between the predetermined second time prior to the predetermined first time may be exemplarily 23 o'clock to 24 o'clock.

The server searches for users who are accessing the server and are under a predetermined age (S20) when the present time is included in the time range.

Here, the users who are under the predetermined age may be, for example, users who are under the age of sixteen. The server may search user information stored in a user database to search for users who are under the predetermined age, that is, users who are under the age of sixteen.

When the search for the users who are under the predetermined age is finished, the server determines whether the present time has reached the predetermined first time, for example, 24 o'clock (S30), and intercepting access to the game server by the searched users who are under the predetermined age (S40) when the present time has reached the predetermined first time.

The server may induce termination of game access by the users who are under the predetermined age by transmitting a shutdown message as a message for notifying terminals of the users who are under the predetermined age of interception of game access when the present time reaches the predetermined first time, before reaching the predetermined first time, for example, at 24 hours 30 minutes.

Also, the server intercepts the access to the game server by the users who are under the predetermined age when the present time reaches the predetermined first time, and stores corresponding information to the user database. The server may reduce rights of the users who are under the predetermined age when playing a game according to a number of times of forcibly intercepting the game access.

In this way, indiscreet access to the game by the users who are under the predetermined age may be controlled.

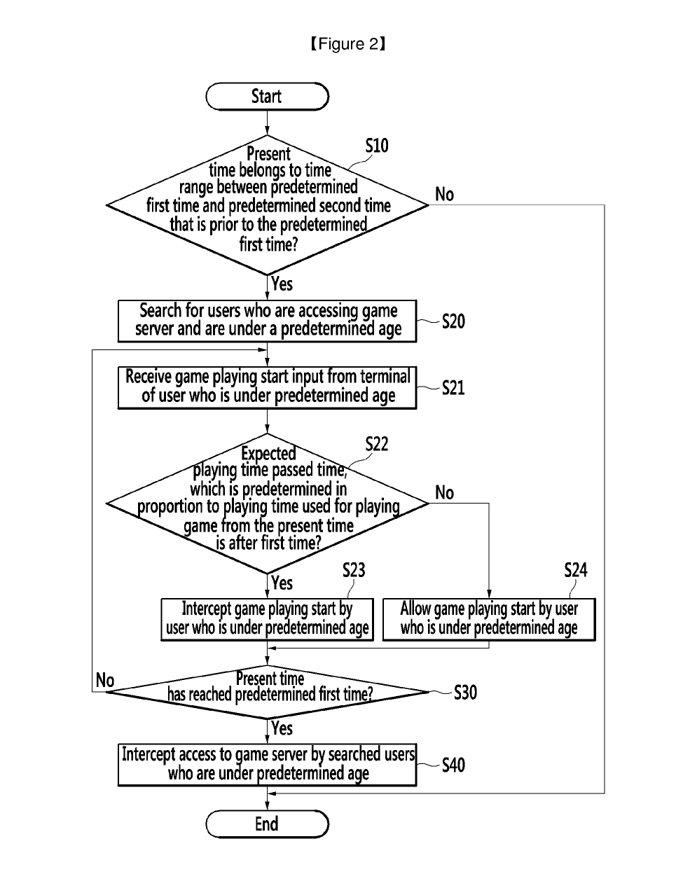

FIG. 2 shows a flowchart of an operation of a method for intercepting playing of a game in a method for providing an online game control service according to an exemplary embodiment of the present invention. Repeated portions that are with described with reference to FIG. 1 will be omitted.

Referring to FIG. 2, when the step S10 for determining by the server whether the present time is included in a time range between the predetermined first time and the predetermined second time prior to the predetermined first time and the present time is included in the time range, the server searches for users who are accessing the server and are under a predetermined age (S20).

After the search for the users who are under the predetermined age is finished, the server receives a game playing start input from a terminal of a user who is under the predetermined age (S21).

Upon receiving the game playing start input from the terminal of the user who is under the predetermined age, the server determines whether an expected playing time passed time, that is, a time which is predetermined in proportion to a playing time used for playing a game from the present time, is after the first time (S22).

When the expected playing time passed time, that is, a time which is predetermined in proportion to a playing time used for playing a game from the present time, is after the predetermined first time, the server intercepts a game playing start by the user who is under the predetermined age (S23).

For example, the expected playing time may be a playing time that is double the playing time of a game. That is, when the user who is under the predetermined age actuates a game playing start button for playing a 20-minute game at 23 hours 30 minutes, the server calculates the expected playing passed time from the present time as 24 hours 10 minutes, which is after the predetermined first time, so the server intercepts the game playing start by the user who is under the predetermined age.

However, when the expected playing time passed time, that is, a time which is predetermined in proportion to a playing time used for playing a game from the present time is before the predetermined first time, the server allows a game playing start by the user who is under the predetermined age (S24).

For example, the expected playing time may be a playing time that is double the playing of a game. As an example, when the user who is under the predetermined age actuates a game playing start button for playing a 10-minute game at 23:30, the server calculates the expected playing passed time from the present time as 23:50, which is before the predetermined first time, so the server allows the user who is under the predetermined age to start playing the game.

The server then determines whether the present time reaches the predetermined first time, for example 24 o'clock (S30), and intercepts the access to the game server by the user who is under the predetermined age (S40) when the present time reaches the predetermined first time.

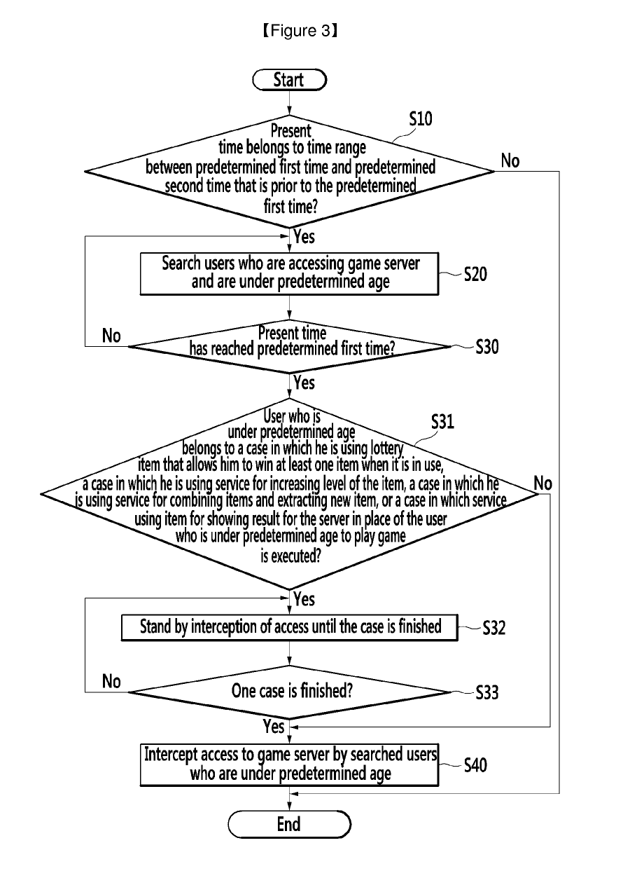

FIG. 3 shows a flowchart of an operation of a method for processing a shutdown exception in a method for providing an online game control service according to an exemplary embodiment of the present invention. Repeated portions that are described with reference to FIG. 1 and FIG. 2 may be omitted.

Referring to FIG. 3, when the step S10 for determining by the server whether the present time is included in a time range between the predetermined first time and the predetermined second time prior to the predetermined first time and the present time is included in the time range, the server searches for users who are accessing the server and are under the predetermined age (S20).

When the search for the users who are under the predetermined age is finished, the server determines whether the present time reaches the predetermined first time, for example, 24 o'clock (S30).

When the present time has reached the predetermined first time, the server determines to which case the user who is under the predetermined age belongs from among a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed (S31).

When one of the above-noted cases exists, the server stands by interception of the access until the executing case is finished (S32).

When (S33) for determining whether one of the cases is finished is performed and the corresponding case is finished, a step (S40) for intercepting the access to the game server by the searched users who are under the predetermined age is performed.

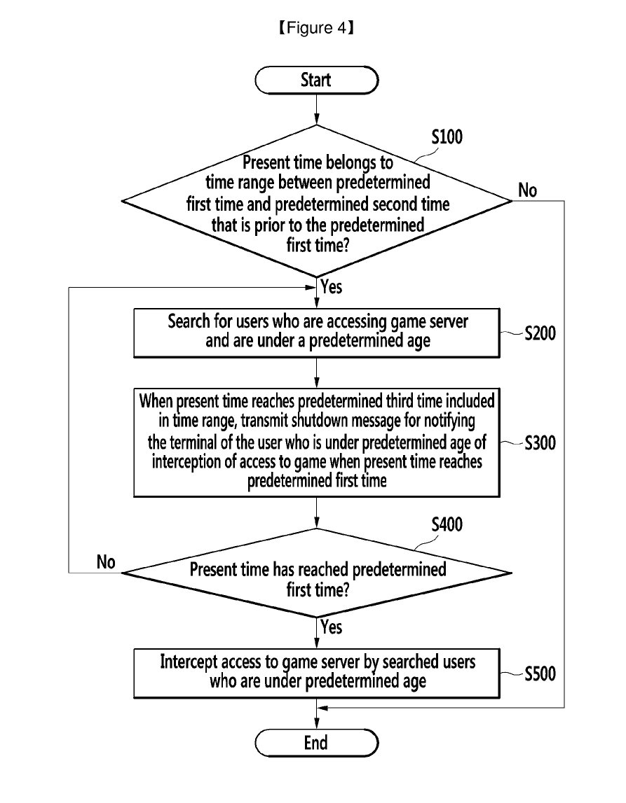

FIG. 4 shows a flowchart of operation of a method for providing an online game control service according to another exemplary embodiment of the present invention. Repeated portions that are described with reference to FIG. 1 to FIG. 3 may be omitted.

Referring to FIG. 4, a method for providing an online game control service according to another exemplary embodiment of the present invention performs, by an online game control service providing server, determining whether a present time is included in a time range between a predetermined first time and a predetermined second time that is prior to the predetermined first time (S100).

When the present time is included in the time range, a step (S200) for searching for users who are accessing the server and are under a predetermined age is performed.

When the search for users who are under the predetermined age is finished, the server transmits a shutdown message for notifying the terminal of the user who is under the predetermined age of interception of access to a game after the present time reaches the predetermined first time, when the present time reaches a predetermined third time included in the time range (S300).

Here, the third predetermined time is a time that is included in a time range between the predetermined second time that is prior to the predetermined first time and the predetermined first time, for example, it may be 23:30 between 23 o'clock and 24 o'clock, and without being restricted to this, any time included in the time range between the predetermined second time that is prior to the predetermined first time and the predetermined first time may be set. When the present time reaches the third time, the server may output a shutdown message to the terminals of the users who are under the predetermined age and induce the users who are under the predetermined age to terminate the game access.

After the shutdown message is transmitted, the server determines whether the present time has reached the predetermined first time, for example, 24 o'clock (S400), and when the present time has reached the predetermined first time, the server intercepts the access to the game server by the users who are under the predetermined age (S500).

The server intercepts the game access by the users who are under the predetermined age when the present time has reached the predetermined first time, and stores corresponding information in the user database. The server may reduce the rights of the users who are under the predetermined age when they play a game according to the number of times of forcibly intercepting the game access.

In this way, indiscreet access to the game by those who will undergo the shutdown can be controlled.

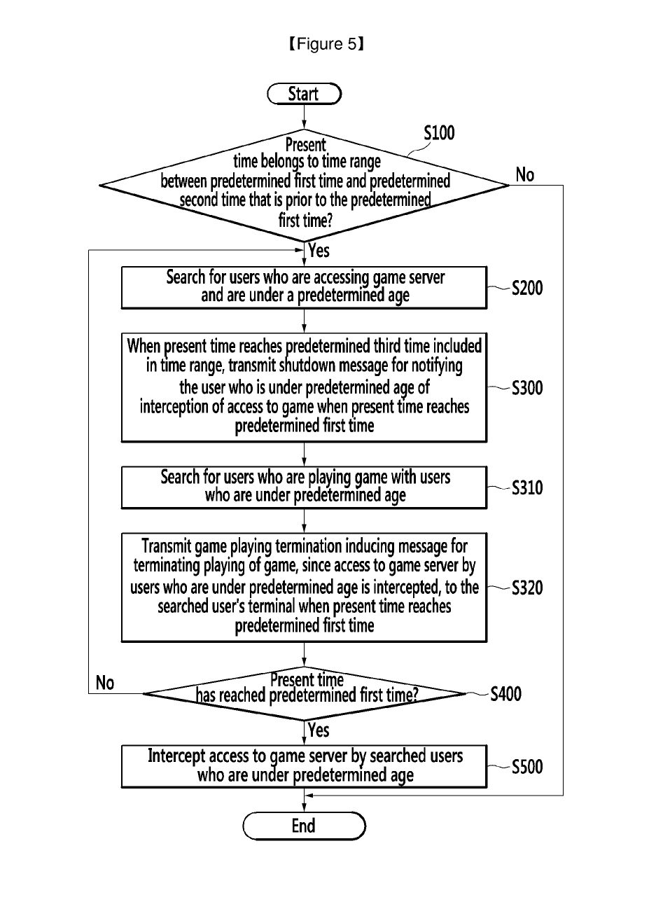

FIG. 5 shows a flowchart of operation of a method for inducing termination of playing of a game between a user who is under a predetermined age and a user who plays the game in a method for providing an online game control service according to another exemplary embodiment of the present invention. Repeated portions that are with described reference to FIG. 1 to FIG. 4 may be omitted.

Referring to FIG. 5, the method for providing an online game control service according to the current exemplary embodiment of the present invention includes a server for providing an online game control service determining whether a present time belongs to a time range between a predetermined first time and a predetermined second time that is prior to the predetermined first time (S100).

The server searches for users who are accessing the server and are under the predetermined age (S200) when the present time is included in the time range.

When the search for the users who are under the predetermined age is finished, the server transmits a shutdown message to the terminal of the user who is under the predetermined age of interception of access to a game after the present time reaches the predetermined first time, when the present time reaches a predetermined third time included in the time range (S300).

After the shutdown message is transmitted, the server searches for users who are playing a game with the users who are under the predetermined age (S310).

When the users who are playing a game with the users who are under the predetermined age are found, the server transmits a game playing termination inducing message for terminating playing of a game, since the access to the game server by the users who are under the predetermined age is intercepted, to the found user terminal when the present time reaches the predetermined first time (S320).

After the shutdown message and the game playing termination inducing message are output, the server determines whether the present time has reached the predetermined first time, for example, 24 o'clock (S400), and when the present time has reached the predetermined first time, the server intercepts the access to the game server by the users who are under the predetermined age (S500).

When the user who is under the predetermined age and the user who is playing a game do not terminate the game playing within the predetermined first time, network accesses of the user who is under the predetermined age and the user who is also playing a game are ended and the game is forcibly finished. Since game points may be deducted when the game is forcibly finished, the playing of a game with the user who is under the predetermined age may be finished before the predetermined first time so as to maintain the game points.

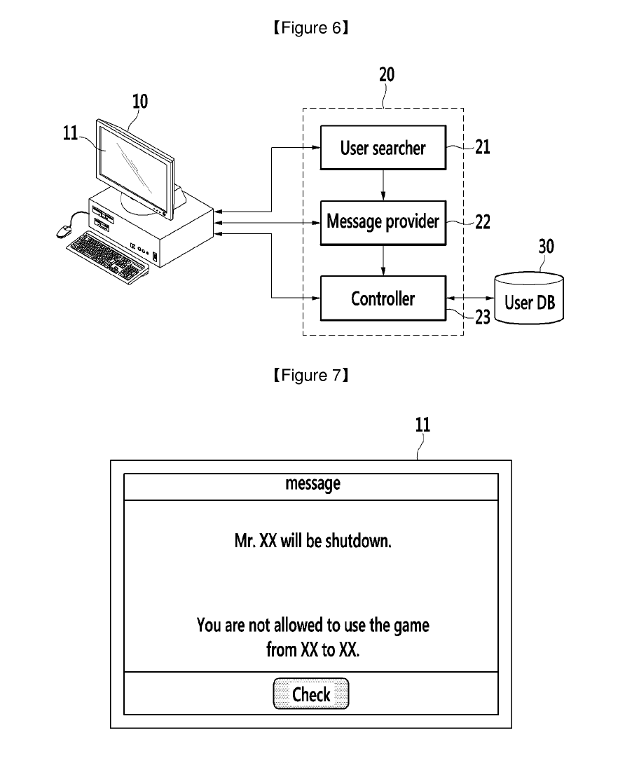

FIG. 6 shows a block diagram of a server for providing an online game control service according to an exemplary embodiment of the present invention.

Referring to FIG. 6, the server 20 for providing an online game control service according to an exemplary embodiment of the present invention is connected to the user terminal 10 and the user database 30. The user database 30 stores personal information of the user inclusive of his identity information and password, and particularly stores the user's age information so the users who are under a predetermined age for shutdown may be found by searching the database 30.

The server 20 for providing an online game control service includes a user searcher 21, a message provider 22, and a controller 23.

The user searcher 21 searches for users who are under a predetermined age accessing the game server 20 when the present time is included in the time range between the predetermined first time and the predetermined second time that is prior to the predetermined first time. The user searcher 21 may search the user database 30 to search for the users who are under a predetermined age.

The message provider 22 generates a shutdown message for notifying interception of the game access when the present time reaches the predetermined first time, and transmits the same to the user terminal who is under the predetermined age when the present time reaches the predetermined third time included in the time range.

The controller 23 intercepts the access to the game server 20 by the searched users who are under the predetermined age when the present time reaches the predetermined first time.

When receiving a game playing start input from the user terminal who is under the predetermined age, the controller 23 determines whether the expected playing time passed time which is set in proportion to the playing time used for playing a game from the present time is after the first time, and then intercepts the game playing start on the user who is under the predetermined age when the passed time is after the first time. However, when the passed time is before the first time, the controller 23 allows the game playing start of the user who is under the predetermined age.

Further, the controller 23 searches for the users who are playing a game with the users who are under the predetermined age, and controls the message provider 22 to transmit a game playing termination inducing message for terminating playing of the game to the searched user's terminal since the access to the game server 20 by the users who are under the predetermined age is intercepted when the present time reaches the predetermined first time.

When present time reaches the predetermined first time, the controller 23 stands by for access interception until a case is finished when the user who is under a predetermined age is included in the one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed. After one case is finished, the access to the game server 20 by the users who are under the predetermined age is intercepted.

The controller 23 intercepts the access of the game server 20, and stores access intercept state information of the game server 20 on the user who is under the predetermined age.

FIG. 7 to FIG. 10 show screens for using an item use service according to exemplary embodiments of the present invention.

Referring to FIG. 7, when the user accessing the game server is included in the group of users who are under the predetermined age and is to undergo the shutdown, the server outputs a message including time available for playing a game together with user identity information to a screen 11 of the corresponding user terminal.

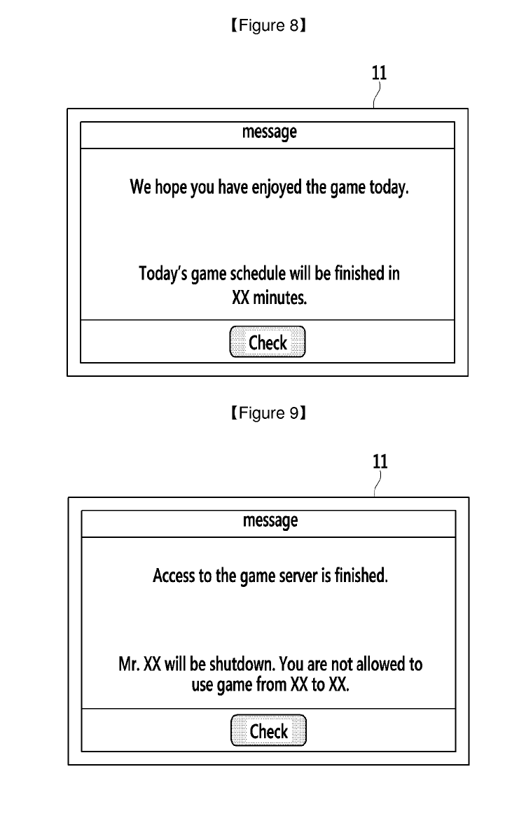

Referring to FIG. 8, a message for showing termination of a current game schedule after a predetermined time is output to a screen 11 of the user terminal who is under the predetermined age starting from the second time included in the predetermined first time.

Referring to FIG. 9, when the present time reaches the predetermined first time, a message for showing that the access to the game server is finished is output to the screen 11 of the user terminal who is under a predetermined age, and the access to the game server is finished.

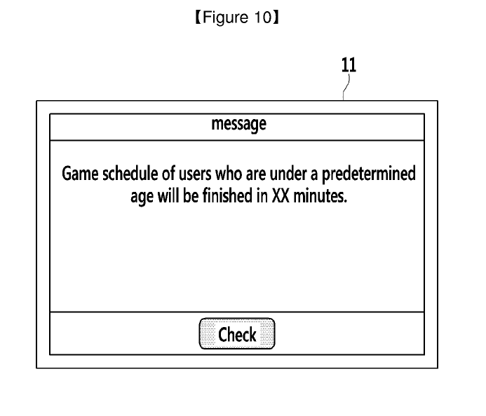

Referring to FIG. 10, when the present time reaches the predetermined first time, a game playing termination inducing message for terminating playing of the game is output to the screens 11 of the terminals of the users who are within the predetermined age range and the user who is playing a game starting from the second time included in the predetermined first time, since the access to a game management server by the users who are under the predetermined age is intercepted.

The method for providing an online game control service according to an exemplary embodiment of the present invention as described above may be executed by the applications (including programs included in a platform, an operating system, or the like which is basically installed in the terminal) which is basically installed in the terminal, and may also be executed by the applications (i.e., programs) which are directly installed in the terminal by the user via the application store server or the application providing server such as the web server associated with the applications or the corresponding services. In this respect, the method for providing an online game control service according to the exemplary embodiment of the present invention may be implemented by the applications (i.e., programs) which are basically installed or directly installed by the user in the terminal and may be recorded in a computer readable recording medium of the terminal, and the like.

The programs are recorded in the computer readable recording medium and are executed by the computer, such that the above-mentioned functions may be executed.

As described above, to perform the method for providing an online game control service according to the exemplary embodiment of the present invention, the above-mentioned programs may include codes which are coded with computer languages such as C, C++, JAVA, machine language, and the like which may be read by a processor (CPU) of the computer.

The code may include a function code associated with a function of defining the above-mentioned functions, and may also include an execution procedure related control code required to allow the processor of the computer to execute the above-mentioned functions as a predetermined procedure.

Further, the code may further include a memory reference related code indicating at which location (address number) of the memory inside or outside the computer additional information or media required to allow the processor of the computer to execute the above-mentioned functions are referenced.

Further, to allow the processor of the computer to execute the above-mentioned functions, when the processor needs to communicate with any other computers or servers, etc. at a remote location, the code may further include a communication-related code about how the processor of the computer communicates with any other computers or servers at a remote location or what information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network, and thus stores and executes a computer readable code by a distributed manner. In this case, at least any one computer among a plurality of distributed computers may execute a part of the above-mentioned functions and transmit the executed results to at least one of other distributed computers, and the computer receiving the result may also execute a part of the above-mentioned functions and provide the executed results to other distributed computers.

Particularly, a computer readable recording medium recorded with applications which are programs for executing the method for providing an online game control service according to the exemplary embodiment of the present invention may be a storage medium (for example, a hard disk, and the like) included in an application store server or an application providing server such as a web server associated with applications or corresponding services, and the like, or an application providing server itself.

A computer which may read a recording medium recorded with applications which are programs for executing the method for providing an online game control service according to the exemplary embodiment of the present invention may include not only general PCs such as a typical desktop and a laptop but also mobile terminals such as a smart phone, a tablet PC, personal digital assistants (PDAs), and mobile communication terminals, and is to be construed as all computable devices.

Further, when a computer which may read a recording medium recorded with applications which are programs for executing the method for providing an online game control service according to the exemplary embodiment of the present invention is mobile terminals such as a smart phone, a tablet PC, a personal digital assistant (PDA), and a mobile communication terminal, the applications are downloaded from an application providing server to a general PC and thus may also be installed in the mobile terminal by a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent piece of hardware, some or all of the respective components which are selectively combined with each other may be implemented by a computer program having a program module performing some or all of functions combined with each other in one or multiple pieces of hardware. The codes and the code segments configuring the computer program may be easily inferred by a person having ordinary skill in the art to which the present invention pertains. The computer programs are stored in the computer readable media and are read and executed by the computer and may implement the exemplary embodiment of the present invention. As the storage medium of the computer programs, a magnetic recording medium, an optical recording medium, and the like may be used.

Further, it will be further understood that the terms “comprises” or “have” used in this specification may include the corresponding components unless explicitly described to the contrary, and therefore do not preclude other components but further include the components. Unless defined otherwise in the detailed description, all the terms including technical and scientific terms have the same meaning as those generally understood by those skilled in the art to which the present invention pertains. Generally used terms such as those defined in a dictionary should be interpreted as having the same meanings as those within a context of the related art, and should not be interpreted as ideally or excessively formal meanings unless clearly defined in the present specification.

The spirit of the present invention has been exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims, and it should be interpreted that all spirits equivalent to the following claims fall within the scope of the present invention.

1. A method for providing an online game control service, comprising:
by a game management server,
determining whether a present time belongs to a time range between a predetermined first time and a predetermined second time that is prior to the predetermined first time;
searching for users who are accessing the game management server and are under a predetermined age when the present time is included in the time range; and
intercepting access to the game management server by the searched users who are under the predetermined age when the present time reaches the predetermined first time.

2. The method of claim 1, wherein
the searching for users who are under the predetermined age includes
transmitting a shutdown message for notifying interception of the game access when a present time reaches the predetermined first time to a terminal of the searched user who is under the predetermined age.

3. The method of claim 1, wherein
the searching for users who are under the predetermined age further includes:
searching for users who are playing a game with the users who are under the predetermined age; and
transmitting a game playing termination inducing message for terminating the playing of a game to the terminal of the searched user since the access to the game management server by the users who are under the predetermined age is intercepted when the present time reaches the predetermined first time.

4. The method of claim 1, further including,
after the searching for users who are under the predetermined age,
receiving a game playing start input from the user terminal who is under the predetermined age;
determining whether an expected playing time passed time that is set in proportion to a playing time used for the playing of a game is after the first time from the present time; and
intercepting the game playing start on the user who is under the predetermined age when the passed time is after the first time.

5. The method of claim 4, further including
allowing a game playing start for the user who is under the predetermined age when the passed time is before the first time.

6. The method of claim 1, wherein
the intercepting of access includes,
when the present time reaches the predetermined first time, standing by for access interception until a case is finished when the user who is under the predetermined age is included in one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

7. The method of claim 1, further including,
after the intercepting of access to a game management server,
storing access interception state information of the game management server on the user who is under the predetermined age.

8. A method for providing an online game control service, comprising:
by a game management server,
determining whether a present time belongs to a time range between a predetermined first time and a predetermined second time that is prior to the predetermined first time;
searching for users who are accessing the game management server and are under a predetermined age when the present time is included in the time range;
transmitting a shutdown message for notifying interception of an game access when the present time reaches the predetermined first time to the user terminal who is under the predetermined age when the present time reaches a predetermined third time included in the time range; and
intercepting access to the game management server by the searched users who are under the predetermined age when the present time reaches the predetermined first time.

9. The method of claim 8, wherein
the intercepting of access includes
when the present time reaches the predetermined first time, standing by for access interception until a case is finished when the user who is under the predetermined age is included in one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

10. The method of claim 8, wherein
the searching for users who are under the predetermined age further includes:
searching for users who are playing a game with the users who are under the predetermined age; and
transmitting a game playing termination inducing message for terminating the playing of a game to the terminal of the searched user since the access to the game management server by the users who are under the predetermined age is intercepted when the present time reaches the predetermined first time.

11. The method of claim 8, further including
after the searching for users who are under the predetermined age,
receiving a game playing start input from the user terminal who is under the predetermined age;
determining whether an expected playing time passed time that is set in proportion to a playing time used for the playing of a game is after the first time from the present time; and
intercepting the game playing start on the user who is under the predetermined age when the passed time is after the first time.

12. The method of claim 11, further including
allowing a game playing start for the user who is under the predetermined age when the passed time is before the first time.

13. A server for providing an online game control service, comprising:
a user searcher for searching for users who are accessing a game server and are under a predetermined age when a present time is included in a time range between a predetermined first time and a predetermined second time that is prior to the predetermined first time;
a message provider for transmitting a shutdown message for notifying interception of game access when the present time reaches the predetermined first time to the user terminal who is under the predetermined age when the present time reaches a predetermined third time included in the time range; and
a controller for intercepting the access to the game server by the searched users who are under the predetermined age when the present time reaches the predetermined first time.

14. The server of claim 13, wherein
when receiving a game playing start input from the user terminal who is under the predetermined age, the controller determines whether an expected playing time passed time which is set in proportion to a playing time used for the playing of a game is after the first time from the present time, and intercepts the game playing start on the user who is under the predetermined age when the passed time is after the first time.

15. The server of claim 13, wherein
the controller allows the game playing start on the user who is under the predetermined age when the passed time is before the first time.

16. The server of claim 13, wherein
the controller searches for users who are playing a game with the users who are under the predetermined age.

17. The server of claim 16, wherein
the message provider transmits a game playing termination inducing message for terminating the playing of a game to the searched user's terminal since the access to the game management server by the users who are under the predetermined age is intercepted when the present time reaches the predetermined first time.

18. The server of claim 13, wherein
when the present time reaches the predetermined first time, the controller stands by for access interception until a case is finished when the user who is under the predetermined age is included in one of a case in which he is using a lottery item that allows him to win at least one item when it is in use, a case in which he is using a service for increasing a level of the item, a case in which he is using a service for combining a plurality of items and extracting a new item, and a case in which a service using an item for showing a result for the server in place of the user who is under the predetermined age to play a game is executed.

19. The server of claim 13, wherein
the controller intercepts the access to a game server and stores access intercept state information of the game management server on the users who are under the predetermined age.

20. A computer readable medium for realizing a method for providing an online game control service, comprising:
by a game management server,
determining whether a present time belongs to a time range between a predetermined first time and a predetermined second time that is prior to the predetermined first time;
searching for users who are accessing the game management server and are under a predetermined age when the present time is included in the time range; and
intercepting access to the game management server by the searched users who are under the predetermined age when the present time reaches the predetermined first time.

21. A computer readable medium for realizing a method for providing an online game control service, comprising:
by a game server,
determining whether a present time belongs to a time range between a predetermined first time and a predetermined second time that is prior to the predetermined first time;
searching for users who are accessing the game management server and are under a predetermined age when the present time is included in the time range;
transmitting a shutdown message for notifying interception of game access when the present time reaches the predetermined first time of the user terminal who is under the predetermined age when the present time reaches a predetermined third time included in the time range; and
intercepting access to the game management server by the searched users who are under the predetermined age when the present time reaches the predetermined first time.
